(19) United States
(12) Patent Application Publication
(10) Pub. No.: US 2026/0277477 A1
(43) Pub. Date: Sep. 17, 2026

(54) TIMED EXCLUSIVE LOCKOUTS FOR MEMORY WRITES

(71) Applicant: SAP SE, Walldorf (DE)

(72) Inventors: Dirk Thomsen, Heidelberg (DE); Werner Johannes Thesing, Lautertal (DE)

(21) Appl. No.: 19/080,512

(22) Filed: Mar. 14, 2025

(51) Int. Cl. G06F 3/06

(52) U.S. Cl. CPC G06F 3/0659; G06F 3/0604; G06F 3/0656; G06F 3/0679

(57) ABSTRACT

Embodiments of the present disclosure include techniques for writing data to persistent memory. In one embodiment, a system periodically enters a shared mode where data pages are written to disk and modified. The system may request exclusive access. If the request is granted, the system may block further modifications to the data pages. Requests for exclusive access may repeat a number of times. If a time period is exceeded without obtaining exclusive access, then the system may force an exclusive access to flush data to disk.

### BACKGROUND

The present disclosure relates generally to memory management in computer software systems, and in particular, to timed exclusive lockouts for memory writes.

Computer systems often store data in different types of memory. For faster access, data is often stored in a fast volatile memory, such as random access memory (RAM). However, RAM loses data when power is removed. Persistent memory retains information after power is removed. Such memories are often referred to as non-volatile memories. Accordingly, computer systems also typically store data in various forms of persistent memory, such as hard disk drives and/or solid state drives (e.g., flash memory).

When multiple types of memories are used, data in the system is typically moved back and forth between RAM and persistent memory. However, data may often be changed as it is being saved. For example, in some cases, data is backed up at intervals, which are sometimes referred to as savepoints or checkpoints. Data that is modified during a savepoint process can lead to inconsistencies between data in volatile and non-volatile memories.

The following disclosure provides various technical solutions to overcome issues related to moving data on and off of persistent memory.

### BRIEF DESCRIPTION OF THE DRAWINGS

FIG. 1 illustrates system using a timed exclusive lockout according to an embodiment.

FIG. 2 illustrates a timed exclusive lockout method according to an embodiment.

FIG. 3 illustrates an example database system with a timed exclusive lockout according to an embodiment.

FIG. 4A illustrates shared mode according to an embodiment.

FIG. 4B illustrates a timed exclusive lockout method according to another embodiment.

FIG. 4C illustrates an example of timed exclusive lockout for savepoints according to another embodiment.

FIG. 5 illustrates hardware of a special purpose computing system configured according to the above disclosure.

### DETAILED DESCRIPTION

Described herein are techniques for timed exclusive lockouts for memory writes. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

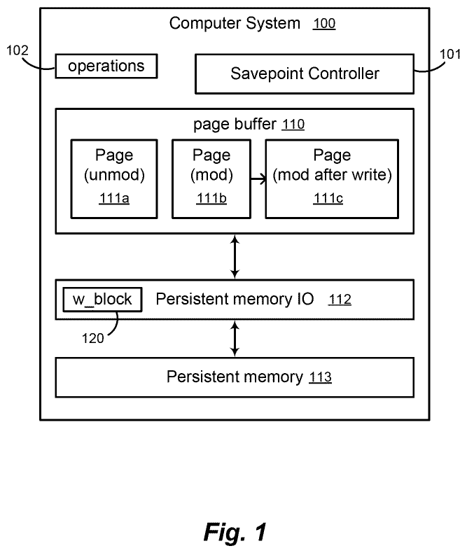

FIG. 1 illustrates a system for timed exclusive lockouts according to an embodiment. Computer system 100 may include, for example, one or more computers comprising one or more processors and a computer readable medium (memory) for executing software to perform the techniques described herein. Here, embodiments of the present disclosure include techniques for reducing the exclusive lockout times for memory writes. Advantageously, the system may execute a request for an exclusive access and the request is granted when none of a plurality of operations are writing modified data pages to a persistent memory in a shared mode at a point in time during a first time period (aka, a try exclusive time period). Otherwise, the request for exclusive access times out after the first time period if the request is not granted during the first time period. In some embodiments, a savepoint may be performed at a floating time, where the savepoint is executed in exclusive mode when the fewest number of shared accesses are being performed.

In particular, page buffer 110 may be associated with reading and writing the data pages to a persistent memory 113. Thus, data pages may be stored in a page buffer 110 as data pages are moved in and out of persistent memory 113, for example. A data page is a block of data associated with software construct, such as a table, container, or file, for example. A table of data, for example, may be divided into data pages having a particular maximum page size (e.g., 16 MB). Related data pages (e.g., from a column of a table) may be coupled together using a variety of techniques, such as B+ trees, linked lists, or the like. As data pages are manipulated by various software programs in main memory (e.g., a volatile memory such as RAM), the data pages are periodically stored in a persistent memory 113 to safeguard the state of the data (e.g., in a non-volatile memory such as a hard disk drive (HDD) or solid state drive (SDD)).

Typically, data pages being written to, or read from, persistent memory 113 are stored in page buffer 110. When a data page is written, or read from, to persistent memory 113, the data page may be sent to, or received from, persistent memory IO 112, which performs writes and reads. When the particular data page has been sent to the persistent memory IO 112 to be written to the persistent memory, the page may have a status indicating the page has been sent to persistent memory IO 112 (e.g., a flag set in a control block associated with the page). The status may change back to a nominal value (e.g., true to false) when the write operation is completed, for example.

Features and advantages of the present disclosure include techniques for reducing the time an exclusive access is used to write data to persistent memory 113. Certain operations 102 executed by computer system 100 may cause data pages to be modified. For example, page buffer 110 includes page 111a that may have been created, but not yet modified, by an operation and page 111b that has been modified by an operation. Periodically, the system may write the pages stored in page buffer 110 to persistent memory. Periodic writes to persistent memory (sometimes referred to as flushes) may be performed by a savepoint controller 101, for example. Such a periodic save may start with the system entering a shared mode (aka, a non-critical phase), where certain operations 102 are allowed to continue performing writes and modifications to the data pages in page buffer 110. In shared mode, the system may write modified data pages (e.g., page 111b) to persistent memory 113 without blocking additional data page modifications by operations 102 that have shared access. For example, in shared mode, modified page 111b may be written to disk and an operation may perform an additional modification on page 111b to produce page 111c. The additional modification may occur while modified page 111b is being written to disk, for example, and therefore must be persisted as well.

Features and advantages of the present disclosure include executing a request for exclusive access to the modified data pages to the persistent memory during a first time period following the shared mode. When the system establishes an exclusive access, the system has entered what is sometimes referred to as a critical phase of operation. For instance, execution of the request blocks new modifications by operations 102 to the data pages in the page buffer. Write blocks are illustrated by “w_block” 120, for example. However, rather than forcing the system into an exclusive access state, the system requests exclusive access for a time period. The request for exclusive access is granted when none of the operations 102 are writing the modified data pages (e.g., page 111c) to the persistent memory 113 in shared mode at a point in time during the time period. The request for exclusive access times out after the time period if the request is not granted during the first time period. The system may re-execute the request for exclusive access a number of times until the request is granted. By repetitively “trying” to obtain exclusive access over a time period, the system effectively searches for the best time to obtain exclusive access that reduces the amount of time required to persist pages to memory in the critical phase, thereby improving overall database performance. When the system establishes exclusive access (e.g., to perform a savepoint), the exclusive access blocks additional modifications by operations 120 to data pages in page buffer 110. Because the critical phase blocks operations, it is advantageous to minimize the time the system spends in the critical phase. As mentioned above, the system may repeat execution of the request for exclusive access after successive first time periods up to a maximum second time period. In some embodiments, after the maximum second time period, the system may invoke exclusive access, forcing the end of shared access and the start of exclusive access. In other words, if the “tries” to obtain exclusive access are not successful after some time period, the system is forced into an exclusive access mode. Invoking exclusive access (e.g., entry into the critical phase) may include blocking new modifications by operations 102 to the data pages in buffer 110 and writing additional modifications (yet to be written) by operations 102 to modified data pages (e.g., page 111c) to persistent memory 113, for example.

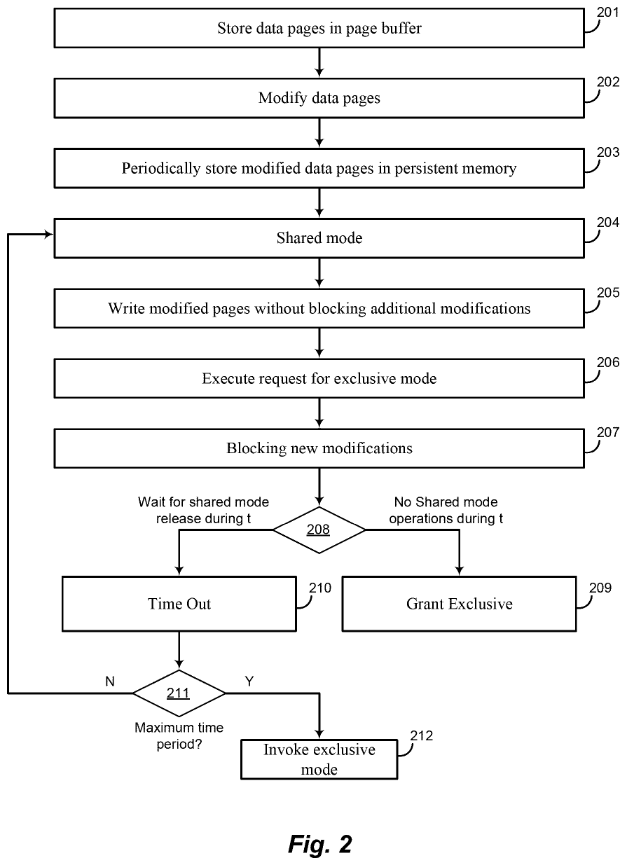

FIG. 2 illustrates an out of memory management method according to an embodiment. At 201, data pages are stored in a page buffer. At 202, the data pages are modified by a plurality of operations to produce modified data pages. At 203, the modified data pages are periodically stored in a persistent memory (e.g., by a savepoint). Periodically storing comprises the following. At 204, the system enters a shared mode. At 205, in a shared mode, the modified data pages are written to the persistent memory without blocking additional modifications by the operations. At 206, a request for exclusive access is executed. At 207, new modifications are blocked. For example, new modifications may be blocked when the request for exclusive access is executed. During a first time period, t, the system determines if any operations are in shared mode. If none of the operations are using shared locks at 208 (e.g., if shared locks are released during t), then the request for exclusive access is granted at 209. Otherwise, the request for exclusive access times out after the first time period at 210 if the request is not granted during the first time period. At 211, the system determines if a maximum time period is reached. If not, the process returns to 204 and stays in shared mode. Execution of the request for exclusive access is repeated after successive time periods up to a maximum time period. If the maximum time period is reached, then exclusive access is invoked at 212.

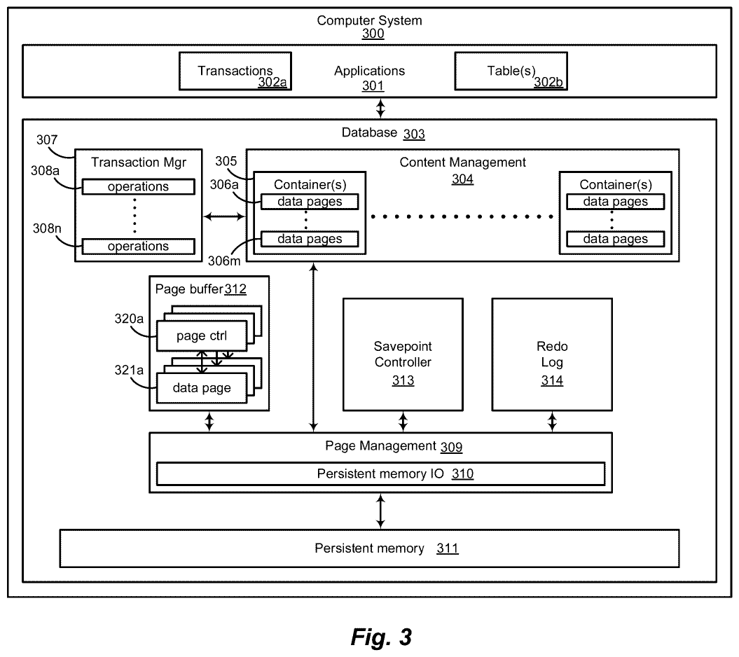

FIG. 3 illustrates an example database system with a timed exclusive lockout according to an embodiment. In this example, the techniques described herein are applied to a database system. For instance, a page buffer, a savepoint controller, and the persistent memory are components of a database. The page buffer may be configured in a volatile memory (e.g., RAM) and the persistent memory may be a non-volatile memory (e.g., HDD or SSD), for example. Computer system 300 may include a plurality of applications 301 executing on one or more processors on one or more computers (e.g., servers or virtual machines). Applications 301 may execute various transactions 302a and on tables of data 302b. Data 302b may also be stored in database 303, and transactions 302a may be managed in database 303 by transaction manager 307. Transaction manager 307 maps transactions to database operations 308a-n, for example. Data is managed by content management 304. For example, for a table with multiple columns, one or more containers 305 may be created in RAM to store the data in the table. In one embodiment, each column of a table may be stored in a different container. In various embodiments, containers are collections of data pages in RAM, which are then stored to persistent memory (aka, disk). Containers may be implemented using B-trees or linked lists, for example. In some embodiments, containers may be fixed in size (e.g., 100 MB) or variable (e.g., for variable characters). In some cases, data in database 303 is converted to data pages. In this example, a column of table data is stored as data pages 306a-m in container 305. Data pages, in turn, may be manipulated by operations 308a-n.

Data pages are written to and read from persistent memory 311 by a page management component 309. Page management 309 may use a page buffer 312 to temporarily store data pages being written to or read from persistent memory 311. Page buffer 312 is sometimes referred to as a page cache, data buffer, or resource container. Contents of the page buffer (e.g., pages from containers) may be stored to persistent memory 311 as is, for example. In this example, each of the data pages (e.g., page 321a) in page buffer 312 is associated with a page control block (e.g., page ctrl 320a). A page control block maintains transient information for the page. In this example, a page control block may include various parameter values, such as an indication of whether or not the page is modified (isModified), a parameter value indicating a particular data page has been sent to a write component (e.g., persistent memory IO 310) to be written to the persistent memory 311 (“inIO”), and other transient page information, for example. Savepoint controller 101 may be part of a persistence layer of the database, for example, including the page buffer, page management, and savepoint controller that manages the flow of data between local memory and persistent memory.

The present example illustrates one advantageous application of the techniques described herein. Here, a persistence layer of the database periodically performs savepoints. During a savepoint operation, modified pages in the page buffer are written to disk. Redo log entries stored in redo log 314 are also written to disk. A database redo log is a set of files that record every change made to a database, essentially acting as a history of all data modifications, allowing the system to “redo” those changes and recover the database to its last consistent state in case of a system crash or unexpected shutdown. Savepoints are used in a wide variety of data storage systems to speed up a restart, where the redo log is processed from the savepoint to restore a system to a recent committed state. Savepoints may be written asynchronously by the savepoint controller 313 (aka, savepoint coordinator). The time interval between savepoints may be configurable, for example. Savepoints may be triggered by a variety of operations, such as periodic data backups, database shutdowns, or after a restart. Thus, if a system crashes, the system can be restored using the last occurring savepoint together with any redo logs that occurred after the last occurring savepoint. As mentioned above, savepoint operations typically are divided into two (2) phases. During the first phase (e.g., the non-critical phase or shared mode), modified data is written to disk and database operations continue as usual. However, during the second phase (e.g., the critical phase or exclusive mode), write operations are blocked and no concurrent write operations are allowed. This is achieved by using an exclusive access (aka, and exclusive lock) mentioned above. However, during this phase, other database operations are impacted, and thus the techniques described herein reduce the time that the system is in exclusive mode to speed up the overall operation of the system.

To ensure consistent changes when persisting modified pages to disk, the system may follow the following steps when modifying data. First, the page management system acquires a savepoint lock in shared mode, which allows concurrent writes to the page. Second, the page is modified. Third, redo log entries are written with undo information. Fourth, a flag is set that indicates the page was modified (e.g., in the page control block for the page being modified). Finally, the savepoint lock in shared mode is released. During a savepoint, for example, modified pages are written to disk, but modifications to the pages may occur in parallel with a write operation, for example.

During normal operation of a database, various operations may have read and write access to data pages. Accordingly, the operations may cause certain data pages to be created, modified, and written to disk during the normal course of operation. However, when a savepoint operation starts, a read/write lock associated with the savepoint can either be acquired in shared mode (aka, non-exclusive mode such that many shared owners in parallel are possible) or in write/exclusive-mode (e.g., only one owner is possible and there is no concurrency). For instance, ReadWrite locks may be either “shared-read” or “exclusive-write.” To avoid lock starvation, the lock may be implemented in a fair manner, e.g. an exclusive-waiter blocks non-exclusive waiters. As long as there is neither an exclusive owner nor an exclusive waiter, the shared lock is always granted. If someone likes to get the lock in exclusive-mode, he needs to wait until all the shared owners are gone. Having an exclusive waiter will now block non-exclusive access as well.

In one example embodiment, the lock is used as follows. (A) an operation which likes to do a page modification (a write to the data page) needs to acquire that lock in shared/read-mode (SM) in order to synchronize against the critical phase of the savepoint. Therefore, many page modifications are possible in parallel. Modifications to the same page as well as to different pages may occur. Note, the modification/write to the data page takes the lock in shared/read mode. But the lock is not to synchronize different modifications to the same page, but to synchronize the page modification with the savepoint. (B) When a savepoint starts, during a first so called non-critical phase, modified pages are written/flushed to disk without incorporating the lock at all. Therefore, nothing is blocked by the savepoint. The pages written to disk might even be modified again in parallel. This kind of flushing may occur several times. In some cases, on each iteration, the amount of pages that need to be flushed decreases. (C) After flushing pages in non-critical phase, we enter the critical phase, which means, the savepoint acquires it's lock in exclusive-mode (EM). As described above, acquiring the lock in exclusive-mode means that the savepoint needs to wait for those operations which already have the lock in shared-mode, but also already blocks those operations which seek to acquire the lock in shared-mode. This is fine, if the shared lock is acquired only for very short periods of time. But it may become a problem, if someone holds the lock in shared-mode for a long time. Steps (B) and (C) are executed by the savepoint thread, while (A) is executed by many different threads.

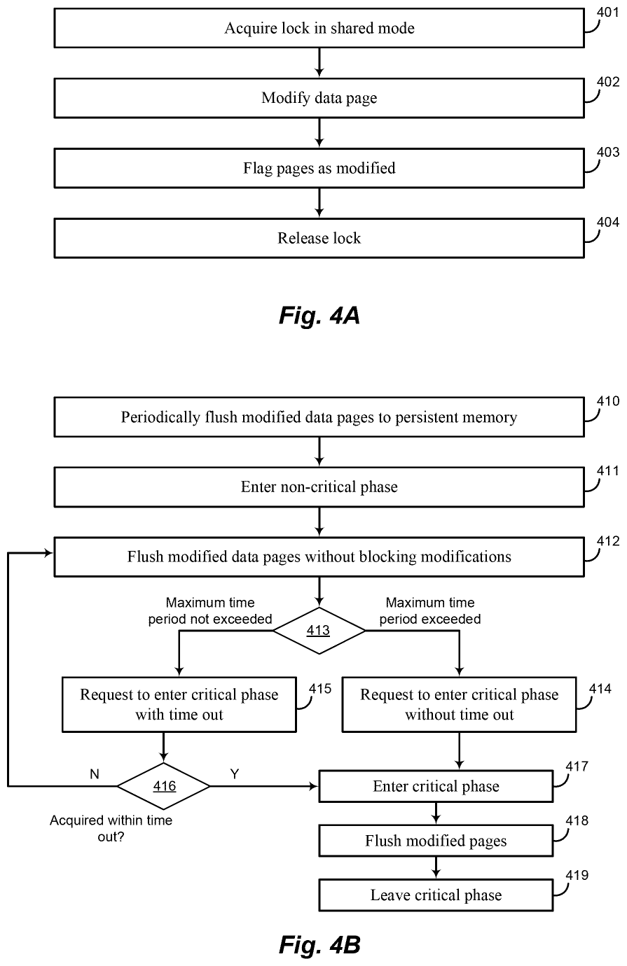

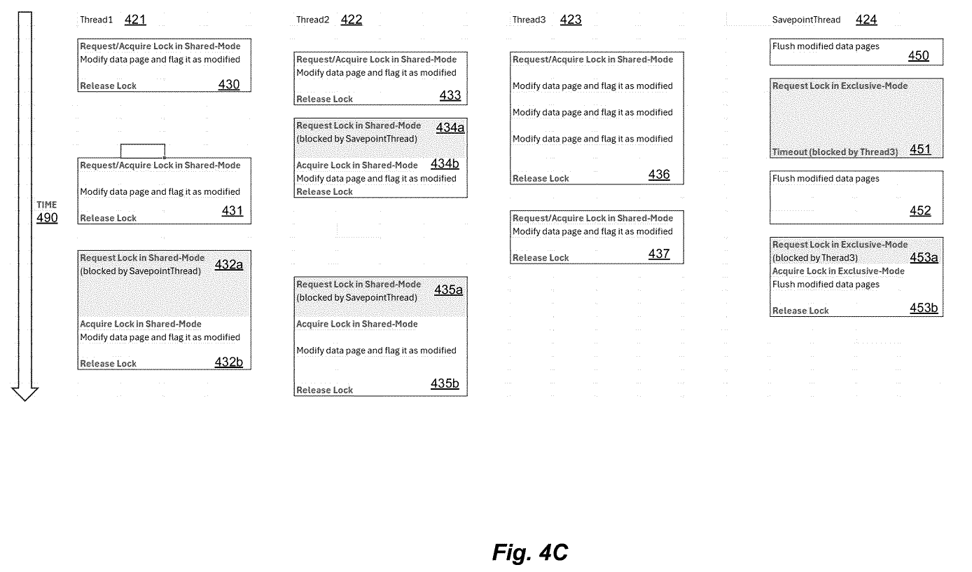

FIG. 4A illustrates shared mode according to an embodiment. At 401, the lock may be acquired in shared mode. At 402, a data page is modified. In various embodiments, the system may write to the redo log and/or write to the undo log, for example. At 403, a flag is set to indicate the data page has been modified (e.g., in the associated control block). At 404, the shared mode lock is released.

FIG. 4B illustrates a timed exclusive lockout method according to another embodiment. At 410, the system periodically flushes modified data pages to persistent memory. At 411, the system enters a non-critical phase. At 412, modified pages are flushed without blocking modifications. In this example, at 413, the system may determine if a maximum time period has been exceeded (e.g., between critical phases. As mentioned above, if the maximum time has been exceeded, a request to enter the critical phase is generated without a time out. Accordingly, the system invokes the critical phase at 417 by waiting as long as necessary for threads in the non-critical phase to finish and release the shared lock. However, if the maximum time is not exceeded, the issues a request to enter the critical phase with a time out and new operations are blocked from acquiring a shared lock. If an operation already using a shared lock (before the request is sent) does not finish within the time out (e.g., an exclusive lock is not acquired within the time out), then the system continues in shared mode and repeats (e.g., up to the maximum time period). However, if the operations in shared mode finishes before the time out, then the system enters the critical phase at 417. At 418, modified pages are flushed and parallel modifications are blocked. At 419, the system leaves the critical phase.

FIG. 4C illustrates an example of timed exclusive lockout for savepoints according to another embodiment. In this example, three (3) threads 421-423 and a savepoint thread 424 are executing along timeline 490. At 450, savepoint 424 is flushing modified data pages in shared mode. Concurrently, thread 421 may request and acquire a lock in shared mode, modify a data page, flag the data page as modified, and release the shared lock at 430. Similarly, starting at a later time, but running concurrently for part of the time, thread 422 performs the same steps as thread 421 at 433, but ends later. Thread 423 starts concurrently with thread 422 but lasts a longer period of time at 436 (e.g., due to additional page modifications). After threads 421-423 have started, savepoint thread 424 issues a request for an exclusive lock with a time out period as illustrated at 451. Processes 430 and 433 finish and release their shared locks before the end of requests time out, but process 436 extends from the beginning of the request to the end of the time out. Thus, the time out expires and the request is blocked by thread 423. Note, after the request is sent, thread 422 issues another request for a shared lock at 434a, but the request is blocked by the pending request for the exclusive lock at 451 until after the time out, at which point thread 422 acquires a shared lock at 434b and proceeds.

After savepoint thread 424 times out, the system may again flushes modified data pages at 452 concurrently with threads 421 and 423 using shared locks at 431 and 437. While process 437 is in progress, another request for an exclusive lock is issued at 453a. Here, the request is not initially granted due to blocking process 437 for thread 423. Accordingly, subsequent requests for a shared lock by thread 421 at 432a and thread 422 at 435a are blocked. After process 437 is completed and releases the shared lock, the request is granted and savepoint thread 424 acquires an exclusive lock and flushes modified pages at 453b. After process 453b completes and releases the exclusive lock, processes 432b and 435b may proceed.

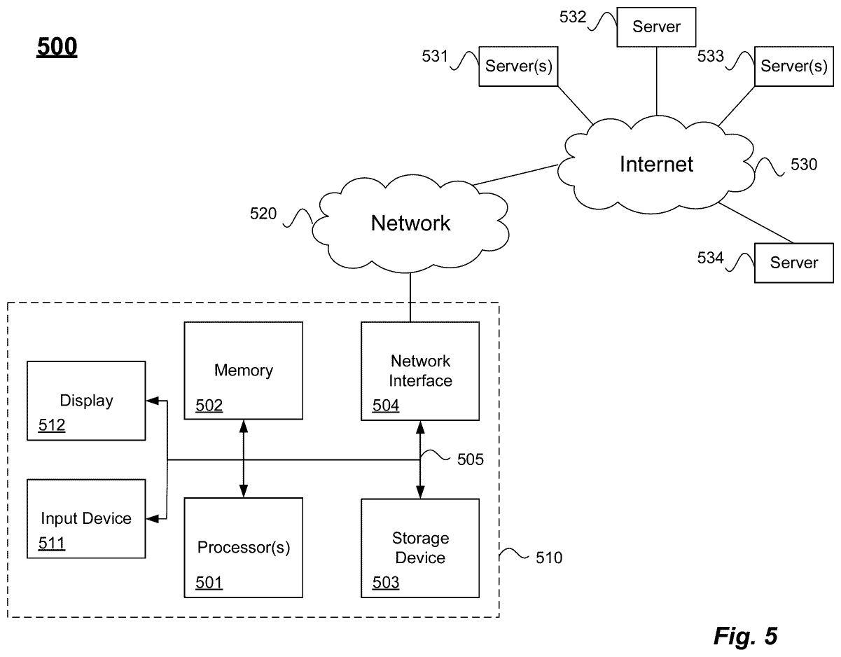

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: storing a plurality of data pages in a page buffer; modifying, by a plurality of operations, the data pages to produce modified data pages; periodically storing the modified data pages in a persistent memory, said periodically storing comprising: in a shared mode, writing the modified data pages to the persistent memory without blocking additional modifications by the plurality of operations to one or more of the modified data pages; and during a first time period following the shared mode, executing a request for an exclusive access to the modified data pages to the persistent memory, wherein execution of the request blocks new modifications by the plurality of operations to the data pages, and wherein the request for exclusive access is granted when none of the plurality of operations are writing the modified data pages to the persistent memory in shared mode at a point in time during the first time period, and wherein the request for exclusive access times out after the first time period if the request is not granted during the first time period.

In one embodiment, exclusive access blocks additional modifications by the plurality of operations to one or more of the modified data pages.

In one embodiment, further comprising repeating execution of the request for exclusive access after successive first time periods up to a maximum second time period.

In one embodiment, further comprising, after the maximum second time period, invoking exclusive access, wherein invoking exclusive access comprises: blocking new modifications by the plurality of operations to the data pages; writing the additional modifications by the plurality of operations to one or more of the modified data pages to the persistent memory.

In one embodiment, further comprising, in the shared mode, modifying, by a plurality of operations, the modified data pages to produce additionally modified data pages, wherein upon granting of the request for exclusive access, the additionally modified data pages are written to persistent memory.

In one embodiment, periodically storing is performed by a savepoint controller.

In one embodiment, the savepoint controller is part of a persistence layer of a database.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
storing a plurality of data pages in a page buffer;
modifying, by a plurality of operations, the data pages to produce modified data pages;
periodically storing the modified data pages in a persistent memory, said periodically storing comprising:
in a shared mode, writing the modified data pages to the persistent memory without blocking additional modifications by the plurality of operations to one or more of the modified data pages; and
during a first time period following the shared mode, executing a request for an exclusive access to the modified data pages to the persistent memory, wherein execution of the request blocks new modifications by the plurality of operations to the data pages, and wherein the request for exclusive access is granted when none of the plurality of operations are writing the modified data pages to the persistent memory in shared mode at a point in time during the first time period, and wherein the request for exclusive access times out after the first time period if the request is not granted during the first time period.

2. The method of claim 1, wherein exclusive access blocks additional modifications by the plurality of operations to one or more of the modified data pages.

3. The method of claim 1, further comprising repeating execution of the request for exclusive access after successive first time periods up to a maximum second time period.

4. The method of claim 3, further comprising, after the maximum second time period, invoking exclusive access, wherein invoking exclusive access comprises:
blocking new modifications by the plurality of operations to the data pages;
writing the additional modifications by the plurality of operations to one or more of the modified data pages to the persistent memory.

5. The method of claim 1, further comprising, in the shared mode, modifying, by a plurality of operations, the modified data pages to produce additionally modified data pages, wherein upon granting of the request for exclusive access, the additionally modified data pages are written to persistent memory.

6. The method of claim 1, wherein said periodically storing is performed by a savepoint controller.

7. The method of claim 6, wherein the savepoint controller is part of a persistence layer of a database.

2. A computer system comprising:
one or more processors;
volatile memory;
non-volatile memory; and
a database system configured to perform a method comprising:
storing a plurality of data pages in a page buffer;
modifying, by a plurality of operations, the data pages to produce modified data pages;
periodically storing the modified data pages in a persistent memory, said periodically storing comprising:
in a shared mode, writing the modified data pages to the persistent memory without blocking additional modifications by the plurality of operations to one or more of the modified data pages; and
during a first time period following the shared mode, executing a request for an exclusive access to the modified data pages to the persistent memory, wherein execution of the request blocks new modifications by the plurality of operations to the data pages, and wherein the request for exclusive access is granted when none of the plurality of operations are writing the modified data pages to the persistent memory in shared mode at a point in time during the first time period, and wherein the request for exclusive access times out after the first time period if the request is not granted during the first time period.

9. The computer system of claim 8, wherein exclusive access blocks additional modifications by the plurality of operations to one or more of the modified data pages.

10. The computer system of claim 8, further comprising repeating execution of the request for exclusive access after successive first time periods up to a maximum second time period.

11. The computer system of claim 10, further comprising, after the maximum second time period, invoking exclusive access, wherein invoking exclusive access comprises:
blocking new modifications by the plurality of operations to the data pages;
writing the additional modifications by the plurality of operations to one or more of the modified data pages to the persistent memory.

12. The computer system of claim 8, further comprising, in the shared mode, modifying, by a plurality of operations, the modified data pages to produce additionally modified data pages, wherein upon granting of the request for exclusive access, the additionally modified data pages are written to persistent memory.

13. The computer system of claim 8, wherein said periodically storing is performed by a savepoint controller.

14. The computer system of claim 13, wherein the savepoint controller is part of a persistence layer of a database.

3. A non-transitory computer-readable medium storing computer-executable instructions that, when executed by at least one processor of a computer system, cause the computer system to execute method comprising:
storing a plurality of data pages in a page buffer;
modifying, by a plurality of operations, the data pages to produce modified data pages;
periodically storing the modified data pages in a persistent memory, said periodically storing comprising:
in a shared mode, writing the modified data pages to the persistent memory without blocking additional modifications by the plurality of operations to one or more of the modified data pages; and
during a first time period following the shared mode, executing a request for an exclusive access to the modified data pages to the persistent memory, wherein execution of the request blocks new modifications by the plurality of operations to the data pages, and wherein the request for exclusive access is granted when none of the plurality of operations are writing the modified data pages to the persistent memory in shared mode at a point in time during the first time period, and wherein the request for exclusive access times out after the first time period if the request is not granted during the first time period.

16. The non-transitory computer-readable medium of claim 15, wherein exclusive access blocks additional modifications by the plurality of operations to one or more of the modified data pages.

17. The non-transitory computer-readable medium of claim 15, further comprising repeating execution of the request for exclusive access after successive first time periods up to a maximum second time period.

18. The non-transitory computer-readable medium of claim 17, further comprising, after the maximum second time period, invoking exclusive access, wherein invoking exclusive access comprises:
blocking new modifications by the plurality of operations to the data pages;
writing the additional modifications by the plurality of operations to one or more of the modified data pages to the persistent memory.

19. The non-transitory computer-readable medium of claim 15, further comprising, in the shared mode, modifying, by a plurality of operations, the modified data pages to produce additionally modified data pages, wherein upon granting of the request for exclusive access, the additionally modified data pages are written to persistent memory.

20. The non-transitory computer-readable medium of claim 15, wherein said periodically storing is performed by a savepoint controller.
